(19) United States
(12) Patent Application Publication
(10) Pub. No.: US 2009/0063177 A1
(43) Pub. Date: Mar. 5, 2009

(54) Web-based services enabling structured secure communication related to the design and management of projects

(76) Inventors: Edward W. East, Mahomet, IL (US); Jeffrey G. Kirby, Champaign, IL (US)

Correspondence Address: HUMPHREYS ENGINEER CENTER SUPPORT ACTIVITY;ATTN: CEHEC-OC, 7701 TELEGRAPH ROAD, ALEXANDRIA, VA, 22315-3860, US

(21) Appl. No.: 11/892,984

(22) Filed: Aug. 29, 2007

(51) Int. Cl. G06Q 99/00

(52) U.S. Cl. 705/1

(57) ABSTRACT

A suite of Web-based services that facilitate design review and checking by enabling the secure structured information exchange of design and related information among authorized business partners and designers in the context of specific business processes. Select embodiments have particular application to those partners, including government agencies, associated with government contracts for construction. A select embodiment, Project ExtraNet (ProjNet^{SM}), incorporating a Design Manager Module, is managed through the National Institute of Building Sciences (NIBS), Government-to-Business Committee. Access to ProjNet^{SM} is available to all personnel associated with a project or program, to include such as consultants, sub-contractors, suppliers, manufacturers, and the like. ProjNet^{SM} hosts a number of specific applications. The most widely used of these applications are DrChecks^{SM}, ProjNet-FILER^{SM} (a file exchange program), and the Design Quality Lessons Learned (DQLL^{SM}) repository.

### RELATED APPLICATIONS

Under 35 U.S.C § 119(e)(1), this application claims the benefit of prior co-pending U.S. Provisional Patent Application Ser. No. 60/841,460, Web-Based Services Enabling Structured Secure Communication Related to the Design and Management of Projects, by East et al., filed Aug. 31, 2006, and incorporated herein by reference.

### STATEMENT OF GOVERNMENT INTEREST

Under paragraph 1(a) of Executive Order 10096, the conditions under which this invention was made entitle the Government of the United States, as represented by the Secretary of the Army, to the entire right, title and interest therein of any patent granted thereon by the United States. This patent and related ones are available for licensing. Contact Bea Shahin at 217 373-7234 or Phillip Stewart at 601 634-4113.

### BACKGROUND

While the design phase of a project represents only a fraction of the life-cycle cost of items such as public infrastructure, decisions made during the design phase impact contributions to life-cycle cost that are not directly chargeable to design but could have been reduced or avoided if considered during the design phase. Taking construction projects as an example, builders, operators, facility users, and others often have suggestions that can improve the constructability, operability, and long-term usefulness of a given facility. Program and project managers typically rely on the physical exchange of hardcopy documents for design review. Geographically dispersed project teams make coordination of a review challenging. Recurring issues or critical items are difficult to track from one project to the next. Consequently, valuable “lessons learned” that might otherwise avert expensive construction change orders and future maintenance headaches are lost. In the construction industry some effort has been undertaken to address improvements in design review.

The Design Review and Checking System (DrChecks^{SM}) is a Web-based data system designed to facilitate the review and feedback of construction project related documents, such as plans and specifications, and is linked to a separate application that will collect and share lessons learned. DrChecks^{SM} is an integrated Web-based business process that allows involved parties to participate in the design-review process via the Internet using common Web browser software. DrChecks^{SM} allows the collection, evaluation, and resolution of issues by geographically separated parties. Management features allow remote change of assignments, due dates, other program features and the like to reflect the evolving nature of work at individual offices.

DrChecks^{SM} may be used to assist in the conduct of design reviews, bidability, constructability, operability, and environmental (BCOE) reviews, and other types of document review. For example, DrChecks^{SM} records review comments and issues, a designer's response to these issues and a reviewer's backcheck (review) of the designer's response to a submitted comment to insure the response is adequate and correct. An integrated E-mail feature may be used to direct additional correspondence to individual reviewers and designers. Such E-mail is saved as part of the project record. To use DrChecks^{SM} one is granted access rights for both the project and their role in a particular project phase, e.g., designer, reviewer, manager, review coordinator, and the like. Project access rights are assigned after registration.

DrChecks^{SM} automatically collects, collates, tracks, and records the commentary of technical discussions. DrChecks^{SM} has demonstrated savings by:
focusing communication with only relevant participants by involving only those parties necessary to participate in a review;
eliminating unnecessary E-mail, teleconferences, and the like;
eliminating document transmission, mailing and faxing;
eliminating some on-site meetings;
addressing specific issues within a structured process;
providing a single access point and a single format of project issues to all participants; and
facilitating use of updated quality standards.

Another useful application that may be used with select embodiments of the present invention is capability provided by a system termed Design Quality Lessons Learned (DQLL^{SM}). DQLL^{SM} may be used to identify and capture recurring issues while conducting a review in DrChecks^{SM}. After the identification of the comment as a potential lessons learned, the comment is forwarded automatically to DQLL^{SM} for evaluation and possible inclusion in a database. The database may be searched by accessing DQLL^{SM} directly or from DrChecks^{SM} during the comment entry process. DrChecks^{SM} demonstrates the impact of integrating a lessons learned application within a legacy application that can both collect and re-use lessons learned within standard business processes.

There are many instances where managers, such as facility owners, need to provide critical design input and feedback to their business partners in “real time.” Business partners often have difficulty finding such information when it is spread throughout large organizations on different Web servers using inconsistent formats. For program managers, keeping tabs on multiple projects on disparate Web sites is not practical. Thus, there is a need for a system and process for facilitating this type of communication with an acceptable level of security.

### BRIEF DESCRIPTION OF DRAWINGS

FIG. 1 illustrates the relationship between levels of management for projects undertaken at a given site as known in the prior art.

FIG. 2 depicts the relationship between the designer's role and that of the manager, reviewer and customer for a particular project, the management of which may be facilitated by select embodiments of the present invention.

FIG. 3 is a flow chart depicting the “Lessons Learned” process as implemented in an embodiment of the present invention.

FIG. 4 is a flow chart depicting the “Criteria Update” process as implemented in an embodiment of the present invention.

FIG. 5 is a flow chart depicting the “Design Review” process as implemented in an embodiment of the present invention.

FIG. 6 is a flow chart depicting the “Design Manager's” activities as implemented in an embodiment of the present invention.

### DETAILED DESCRIPTION

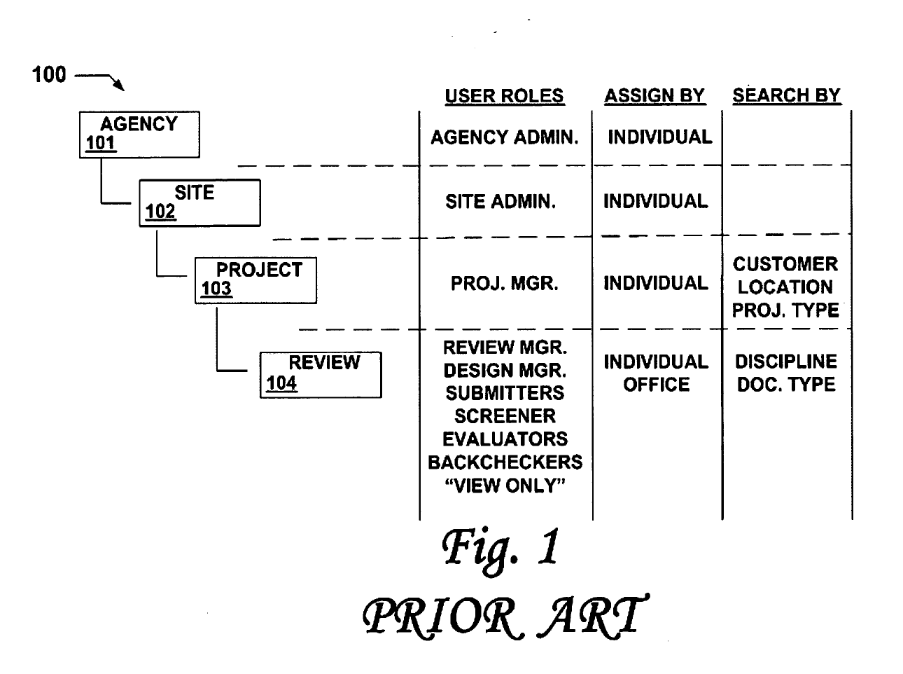

Refer to FIG. 1 (Prior Art), a chart 100 of relationships among a responsible agency, a site under the management of that agency, a project being accomplished at that site, and the various reviewers of the project during implementation. Under “User Roles,” it is seen that the Agency is responsible for administering all sites under its jurisdiction, the Site has responsibility for administering all resources located at the site, the Project manager is responsible for a particular project ongoing at the site, such as construction of a new building, and the Reviewers (manager, submitters, screener, evaluators, backcheckers and the like) are responsible for “oversight” to insure that the project fulfills requirements and meets performance, schedule and budget constraints.

For the Agency, Site and Project, an individual is assigned as the overall administrator at each of the respective levels. For the “Review” function, an individual or an office may be assigned responsibility for oversight of a particular project at a site. To locate information on the project, one may “search by” customer, location or project type at the “Project” level. At the “Review” level, one may search by a particular discipline (buildings, roads, causeways, and the like) or a document type (plans, engineering change notices, progress reports, and the like). The options are limited for facilitating open communication and “real time” issue resolution, given just the structure provided in FIG. 1 and no means by which to efficiently and effectively communicate with key participants.

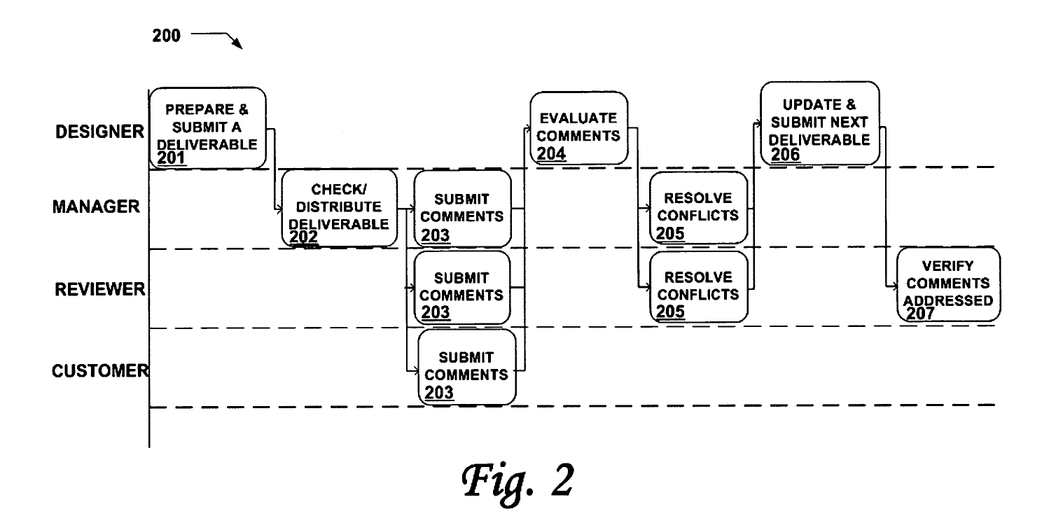

Refer to FIG. 2, a flow chart 200 of the relationships among designers, managers, reviewers, and a customer for a project. Most projects are initiated by a customer requirement (not shown separately). A designer prepares and submits a “Deliverable” 201, a design of a product or service suitable to meet the customer's requirement. A manager checks and distributes the Deliverable 202 to other managers and reviewers as well as the customer, before committing to completing the project. The managers, reviewers and the customer return their comments 203 to the designer. The designer evaluates the comments 204 and enlists the support of the managers and reviewers to resolve any differences 205 between the comments and the designer's evaluation 204. Once resolved, changes to the design, if any, are updated 206 by the designer and forwarded to the reviewers to verify that the comments were adequately addressed 207. This process could require considerable time and effort were it not for a suite of Web-based services enabling structured secure communication among the key stakeholders peculiar to each of the different phases of the project. One such suite for managing construction projects is described in an example below.

Select embodiments of the present invention envision Web-based services that facilitate design review and checking by enabling structured secure communication among parties associated with design and management of projects, to include Requests for Proposals (RFPs) for said projects. Embodiments comprise: a design checklist module such that the design checklist module facilitates the review of project related documents and feedback thereon, and such that the design checklist module enables collection and sharing of lessons learned, and such that the design checklist module integrates a Web-based business process permitting the parties to participate in a design review process using Web browser software and internet access, and such that the design checklist module permits parties to make changes to reflect the evolving nature of work, and such that the design checklist module incorporates a feature that integrates E-mail useful for directing correspondence to select parties, and such that the E-mail may be saved as part of a record of the project; a file management module, such that the file management module facilitates the secure exchange of project documents among interested parties, and such that the file management module automatically tracks document creation, deletion, and file views, and such that the file management module facilitates audit trails permitting interested parties to verify key parties having access to latest versions of the project documents; a criteria management system (CMS) incorporating at the least a criteria change request (CCR) module, such that the CCR module facilitates one in requesting changes to federal criteria, requirements, regulations and guidelines; and a standards and criteria program (SCP) module, such that the SCP module permits parties to coordinate work on shared documents and manage allocation of resources and status of projects in accordance with internal processes and guidelines, and such that the CMS allows the parties that are federal agencies that may employ the Unified Facilities Guide Specification (UFGS) to manage the CCRs, points of contact for specific documents and control versioning of Government specifications as well as the federal agencies' internal regulations and guidelines; a plan room module, such that the plan room module permits contracting officers to publish contract bid documents to accommodate the RFPs; a bid module, such that the bid module permits prospective bidders on the projects to have questions answered by contracting office staff; a request for information (RFI) module, such that the RFI module permits contractors to resolve contract issues by employing a formal process administered by a contracting officer; a design quality lessons learned (DQLL^{SM}) module, such that the DQLL^{SM} module permits owners to capture, evaluate, and re-use documentation and resolve recurring issues, incorporate location criteria, and address customer requirements; a design manager's module, such that the design manager's module aids designers in controlling internal work processes and allows assignment of discipline lists to assist with comments to be reviewed and approved by a design manager, and such that the design manager's module provides specific edit tools and specific reports; a tasker module, such that the tasker module is a calendar-based application allowing the managers and users to manage the work on multiple projects identified across any other modules in the Web-based services; a call center module, such that the call center module permits the capture and resolution of issues related to the use of any of the modules in the Web-based services; an on-line training module, such that the on-line training module permits users to learn how to use the modules of the Web-based services; and a security sub-system, such that the security sub-system permits Web-based services modules to use a shared security model that enforces federal information processing standards.

Select embodiments of the present invention may be used to facilitate management of construction projects.

Select embodiments of the present invention may be implemented on one or more computers. Select embodiments of the present invention may be incorporated on computer readable material in whole or in part.

Select embodiments of the present invention provide Web-based services enabling structured secure communication among parties associated with design and management of projects. One of the services comprises a design checklist module that facilitates the review of project related documents and feedback thereon; enables collection and sharing of lessons learned; integrates a Web-based business process permitting the parties to participate in a design review process using Web browser software and internet access; permits parties to make changes to reflect the evolving nature of work; and incorporates a feature that integrates E-mail useful for directing correspondence to select ones of the parties, while permitting the E-mail to be saved as part of a record of the project.

Another of the services is a file management module that facilitates the secure exchange of project documents among interested parties; automatically tracks document creation, deletion, and file views; and facilitates audit trails permitting interested parties to verify key parties having access to latest versions of project documents.

A third service is a criteria management system (CMS) module that allows the parties that are federal agencies using the Unified Facilities Guide Specification (UFGS) to manage and control content of Government specifications as well as said federal agencies' internal regulations and guidelines.

A fourth service is a criteria change request (CCR) tool that permits the public to request changes to federal criteria, requirements, regulations, and guidelines.

### EXAMPLE I

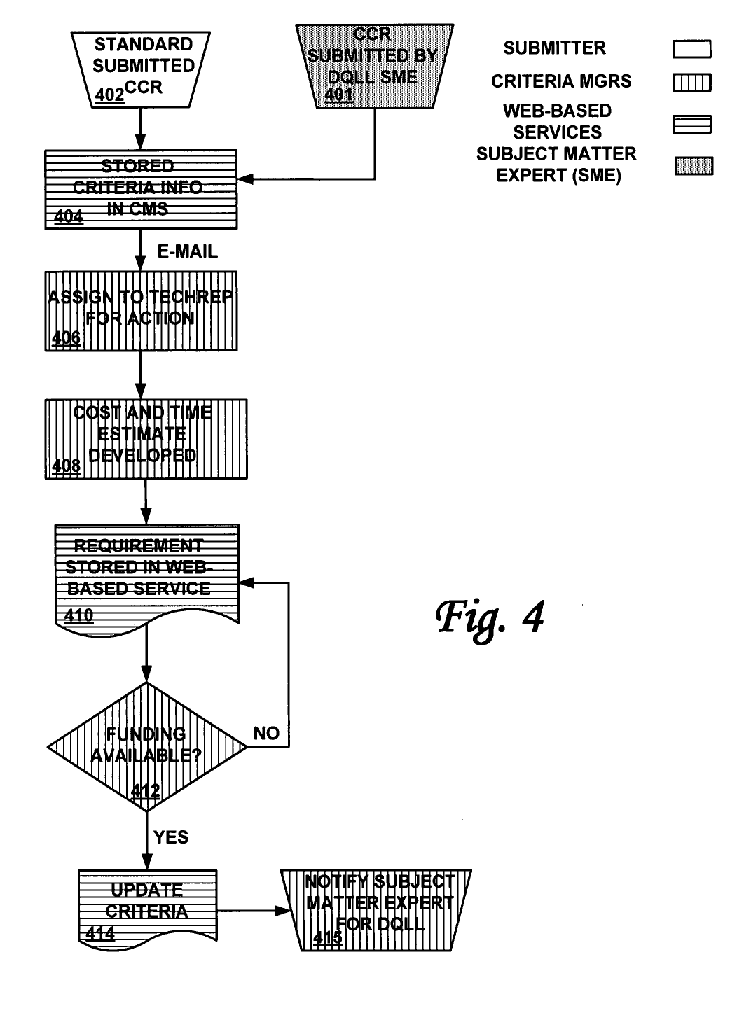

Refer to FIG. 4, a flow chart describing the interactions that may occur in using the Criteria Change Request (CCR) module. A submitter submits a standard CCR 402 to be stored 404 in the database of the CMS module. A submittal may also be made via a subject matter expert (SME) associated to the DQLL^{SM} module as indicated by action 401. An E-mail notice is sent assigning 406 the request to a technical representative for action. Once the technical representative takes action a cost and time estimate is developed 408 and the requirement is then stored 410 in the fifth service, a standards and criteria program (SCP) module that permits parties to coordinate work on shared documents and manage allocation of resources and status of projects in accordance with internal processes and guidelines. Upon checking availability of funding 412, the requirement is either stored 410 in the ProjNet^{SM} database or, if funding is available, the criteria are updated 414 and the SME listed in the DQLL^{SM} notified 415 to close the loop.

A sixth service is a plan module that permits contracting officers to publish contract bid documents and requests for proposal (RFPs).

A seventh service is a bid module that permits prospective bidders on the projects to have questions answered by contracting office staff.

An eighth service is a design quality lessons learned (DQLL^{SM}) module that permits owners to capture, evaluate, and re-use documentation and resolve recurring issues, incorporate location criteria, and address customer requirements.

### EXAMPLE II

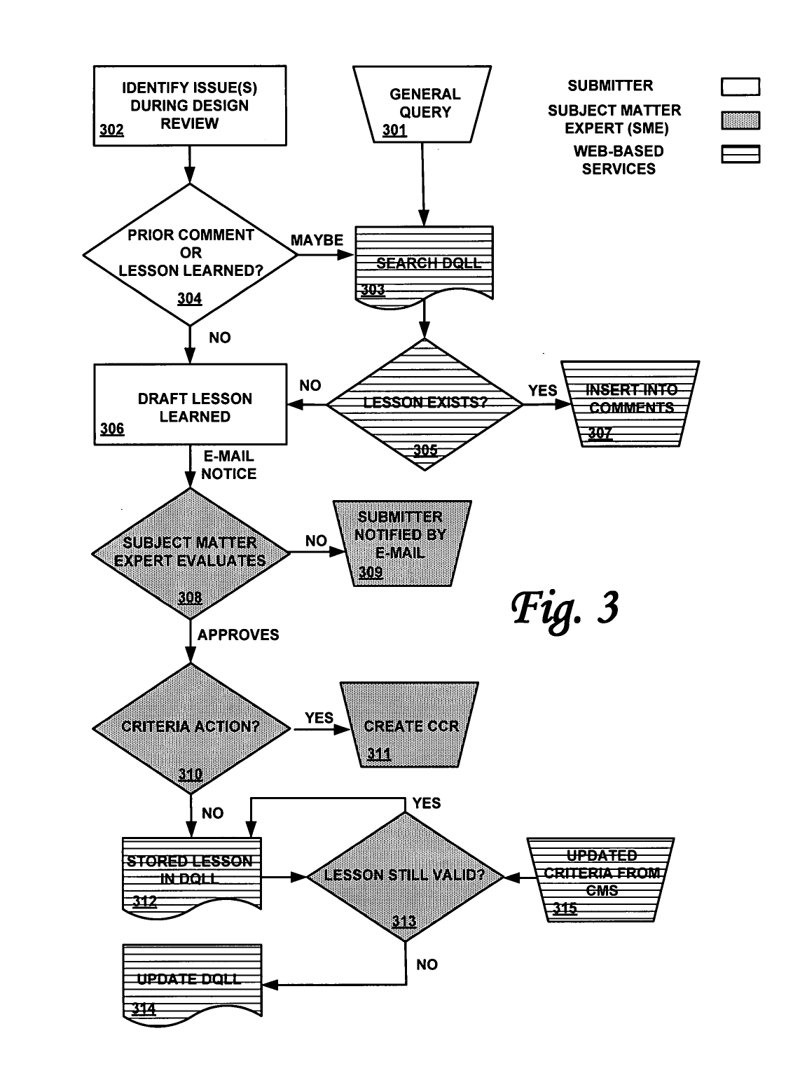

Refer to FIG. 3, a flow chart describing the interactions that may occur in using the DQLL^{SM} module. One or more issues are identified 302 by a submitter. A query is initiated 304 as to whether it is an existing lessons learned (lesson). If it is new, then a new lesson is drafted 306. If unsure as to whether it is new, a search 303 of the DQLL^{SM} database is made. This same search 303 may be initiated by a general query 301 unrelated to an issue. A lesson may exist in the DQLL^{SM} as indicated by the decision 305. If a lesson does exist, that lesson is inserted 307 into comments for the project. If a lesson does not exist, a lesson is drafted 306. An E-mail notice of the newly drafted lesson is sent to a subject matter expert (SME) who evaluates 308 it. If the lesson is found to be of no merit or duplicative the submitter is notified 309 by E-mail. If the lesson has value the SME approves it (submitter is notified 309 by E-mail) and determines if a criteria action 310 is required. If the answer is yes, a criteria change request (CCR) is created 311. If no, then the lesson is stored 312 in the DQLL^{SM} database. The lesson may be further questioned 313 as to its validity at any time, possibly based on updated criteria from the Criteria Management System (CMS) 315. If still valid, it is permitted to remain stored 312 in the DQLL^{SM} database. If it is found to have been superseded or duplicative, then the DQLL^{SM} database is updated 314.

A ninth service is a design manager's module that permits designers to assign a secondary specific discipline, assign the comments to be reviewed and approved by a design manager and provides specific edit tools and specific reports.

### EXAMPLE III

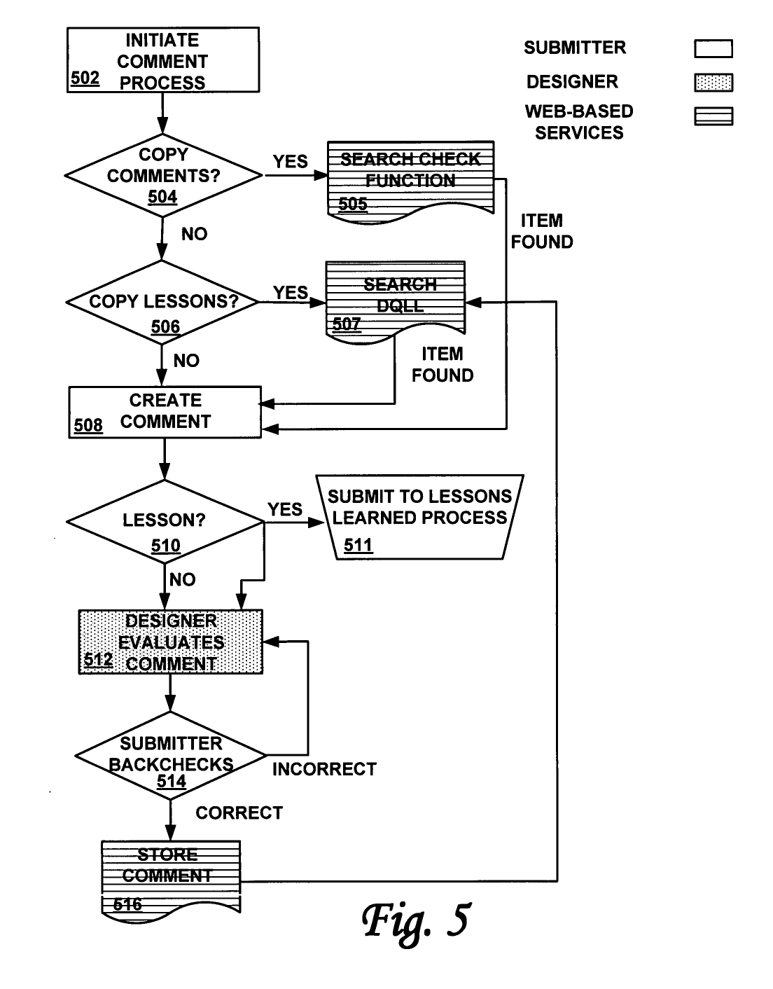

Refer to FIG. 5, a flow chart describing the interactions that may occur in using the Design Manager's module to implement a design review process. A “comment process” is initiated 502, often by the designer. A decision is made whether it is appropriate to copy comments 504. If yes, then a search 505 is made of the check function (for ProjNet^{SM}, this is DrChecks^{SM}). If one or more items are found, they are used to create a comment 508. If it is decided not to copy comments, a decision to copy lessons 506 is made. If yes, a search 507 of the DQLL^{SM} database is made. Again, if one or more items are found, they are used to create a comment 508. If neither one nor both of the comments or lessons are copied, a comment is created 508 noting this. Next, it determined if a lesson 510 be documented. If yes, a draft is submitted to through a Lessons Learned process such as that described in Example II as well as provided to a designer to evaluate 512. If a lesson is found not to be required, a designer evaluates 512 the initial comment.

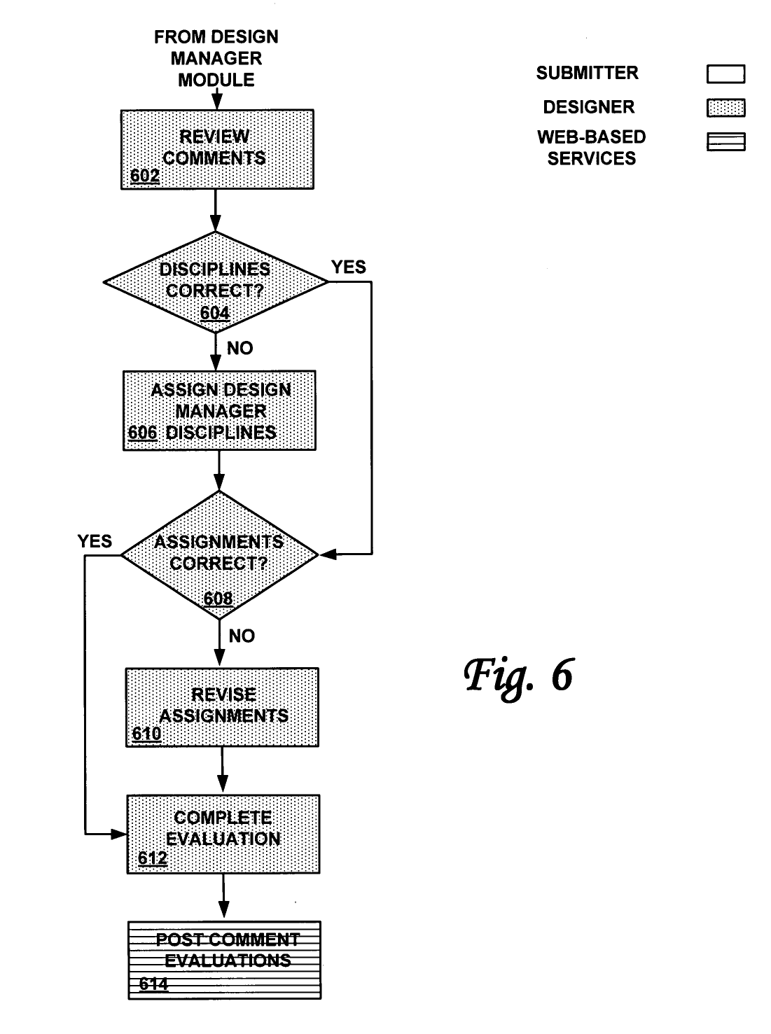

Refer to FIG. 6, a flow chart describing actions that may be expected from a Design Manager. The Design Manager function allows the Design Manager internal control of the design review process by permitting a design manager to assign ‘secondary’ disciplines for the firm to use internally to sort the comment set for action; to control the assignment of who will perform the evaluations and to prevent other project participants from seeing the evaluations until the evaluation is completed. Beginning at the comment review 512, the design manager first asks if the disciplines are correct 604. If no, the design manager assigns 606 the correct disciplines. If yes, a determination 608 is made if the assignments are correct. If correct, the design manager completes the evaluation 612. If not, the assignments are revised 610. Once the design manager's evaluation is complete and backchecked 514 (FIG. 5), the comment evaluations are posted 614 for backchecking by the submitter.

Referring once again to FIG. 5, once a design manager has completed his evaluation and it is sent to the submitter for backchecking, the submitter “backchecks” 514 the evaluation. If the submitter agrees with the designer, i.e., the evaluation is correct, the comment is stored in the checking function (DrChecks^{SM} for ProjNet^{SM}) along with the evaluation and backcheck. If the submitter disagrees with the designer, the evaluation is sent back to the designer for another evaluation 512, re-cycling the process at that stage.

A tenth service is a tasker module that is a calendar-based application allowing managers and users to manage the work on multiple projects identified across any other said modules in the Web-based services.

An eleventh service is a call center module that permits the capture and resolution of issues related to the use of any of the modules in the Web-based services.

A twelfth service is an on-line training module that permits users to learn how to use the modules of the Web-based services.

A thirteenth service is a request for information (RFI) module that permits responses to requests by construction contractors.

A fourteenth service is a security sub-system that permits Web-based services modules to use a shared security model that enforces federal information processing standards.

Select embodiments of the present invention may be use in the management of construction projects as described in the following example.

### EXAMPLE IV

Project ExtraNet (ProjNet^{SM}) provides a suite of Web-based services for the secure structured information exchange of design and construction information among authorized business partners in the context of specific business processes, in particular those partners, including government agencies, associated with government contracts. ProjNet^{SM} is managed through the National Institute of Building Sciences (NIBS), Government-to-Business Committee. It is accredited by the Office of Diplomatic Security, U.S. Department of State, for processing Sensitive But Unclassified (SBU) and For Official Use Only (FOUO) information, as well as publicly available information. Reference ProjNet^{SM} User's Manual, Construction Engineer Research Laboratory (CERL), Engineer Research and Development Center (ERDC), U.S. Army Corps of Engineers, Champaign, Ill., 159 pp, 2006 and Appendix: Design Manager's Guide thereto, 5 pp, 2006, both incorporated herein by reference.

Access to ProjNet^{SM} is available to all personnel associated with a project or program, to include such as consultants, sub-contractors, suppliers, manufacturers, and the like. ProjNet^{SM} hosts a number of specific applications. The most widely used of these applications are DrChecks^{SM}, ProjNet-FILER^{SM} (a file exchange program), and the Design Quality Lessons Learned (DQLL^{SM}) repository. The suite of services available through ProjNet^{SM} includes:
DrChecks^{SM};
QuickPick, allowing the capability to retrieve relevant past review comments, lessons learned, or specific checklists;
ProjNet-FILER^{SM}, providing secure exchange of electronic documents available through ProjNet^{SM};
Criteria Management System (ProjNet-CMS^{SM}), allowing federal agencies using the Unified Facilities Guide Specification (UFGS) to manage and control content of requested changes to government-wide specifications as well as their internal regulations and guidelines;
Criteria Change Request (ProjNet-CCR^{SM}) tool, allowing the public to request changes to federal criteria, requirements, regulations, and guidelines; a record of these CCRs is maintained within ProjNet-CMS^{SM};
Standards and Criteria Program (ProjNet-SCP^{SM}), allowing agencies to coordinate, manage and fund work on shared documents, regulations and guidelines; ProjNet-SCP^{SM} allows one to manage the funding necessary to implement the CCRs stored in ProjNet-SCP^{SM}; ProjNet-SCP^{SM}, ProjNet-CCR^{SM} and ProjNet-CMS^{SM} are interdependent and share a common database;
ProjNet-PlanRoom^{SM}, allowing contracting officers to publish on the internet contract bid documents and requests for proposal (RFPs) to allow ready access by potential proposers;
ProjNet-BID^{SM}, allowing prospective bidders to have questions on a bid package answered by contracting office staff;
ProjNet-Design Quality Lessons Learned (DQLL^{SM}), allowing owners to capture, evaluate, store and re-use lessons learned related to recurring issues, location specific issues, and customer requirements;
ProjNet-Design Manager's Module (ProjNet-DMM^{SM}), allowing designers to “hide” intermediate work products from other review participants, edit review evaluations, assign others to accomplish the evaluations and assign firm specific secondary disciplines for internal sorting and processing; the ProjNet-DMM^{SM} also provides specific edit tools and specific reports;
e-TASKER^{SM}, a calendar-based application allowing managers and users to manage the work identified across any ProjNet^{SM} application on multiple projects;
Call Center, allowing the capture and resolution of issues related to the use of any ProjNet^{SM} application;
On-line Training, allowing new users to learn the system and existing users to learn about updates to the system;
ProjNet-Request For Information (ProjNet-RFI^{SM}) module, allowing responses by contracting staff to requests by construction contractors, and a
Security Sub-System, allowing all ProjNet^{SM} applications to use a shared security model that enforces federal information processing standards.
ProjNet^{SM} provides a sustainable approach to capturing recurring issues to include a broad set of lessons learned. These lessons learned may contain success stories, good work practices, critical issues, recurring issues, and the like.

Without ProjNet^{SM} there is no single point for providing a secure method for internet exchange of “sensitive” project information. E-mail attachments and vendor FTP servers do not provide sufficient security to meet user requirements, e.g., federal requirements, such as Department of Defense (DoD) and Office of Personnel Management (OPM) regulations. Generally, commercial project management services are unable to control access to servers and databases.

ProjNet^{SM} applications provide a number of tangible project benefits. DrChecks^{SM}, for example, reduces meeting time and cost, eliminates collating of comments submitted in a variety of formats, promotes participation by facility managers and owners, and speeds reviews. ProjNet^{SM} saves time and resources, resulting in a higher quality design for no increase in cost.

Agencies employing ProjNet^{SM} may create information distribution portals for a variety of programs. They may use portals for the distribution of standard design documents, guidelines, Architect/Engineer guidelines, and other standards.

The content at portals is managed by subject matter experts in the agency, and overseen by agency administrators. As needed, a portal manager may update contacts to keep all business partners abreast of latest standards.

ProjNet-DQLL^{SM}, developing, managing and allowing access to the lessons learned subject matter repository, allows reviewers to identify possible lessons learned as they conduct reviews. The context of the comment, i.e., the customer, location, type of work, and the like is already identified to the project under which the pending item is submitted and is automatically captured.

Once submitted, a pending item is evaluated by designated regional and/or national subject matter experts. As appropriate, these experts may forward approved submissions as a criteria change request (CCR) by ProjNet-CCR^{SM} to be considered for inclusion in future updates to standards or criteria.

The majority of the issues captured within DQLL^{SM}, and not forwarded on for criteria updates, relate to location and customer specific criteria. The capture of such issues is critical as the workforce changes, especially if the number of local technical experts is reduced.

While the capture and approval of lessons learned is commendable, the real value of a lesson is in timely learning. Thus issues that have yet to be translated into updated requirements are available to the reviewer based on a simple, but powerful search engine. Users may retrieve approved lessons learned related to any combination of discipline, location, customer, project type, keyword, and the like. Once identified these items may be used as a checklist for a current project.

The subject matter repository within the DQLL^{SM} assists new project or program managers, contractors, vendors, and the like by early transfer of important lessons that improve the quality of design, thus reducing the cost of construction.

The ProjNet-RFI^{SM} module provides a structured process for Contracting Officers to respond to questions raised by firms under contract to build facilities. RFI's are submitted by registered ProjNet^{SM} contractors and forwarded by E-mail to the appropriate expert on the RFI evaluation team as well as designated Project/Review Managers. When the RFI issue has been finalized by the Contracting Officer (or representative), an answer is E-mailed to the submitter of the RFI.

Construction project submittals may be securely transmitted using the ProjNet-Submittal Register application (ProjNet-SR^{SM}). ProjNet-SR^{SM} provides a structured process by which requested submittals can be tracked and responded to in a timely manner. Contractors may use this tool to submit details of their chosen submittals (typically as .pdf files). This application tracks communications between contractors and interested parties to insure that the contractors' submittals meet contractual requirements. Integrated E-mail tools provide notification to appropriate parties as to status of action taken.

The ProjNet-FILER^{SM} application facilitates the secure exchange of project documents among and between all project stakeholders. ProjNet-FILER^{SM} automatically tracks document creation, deletion, and file views. Audit trails allow team members to verify relevant personnel having latest versions. To protect sensitive information, documents relating to items such as fire protection systems, emergency power systems, controlled access areas and the like should not be made available to the public. Attaching such sensitive documents to E-mail or making them available through FTP is prohibited. These security requirements extend to bid documents as well as information exchange among consultants, subcontractors, suppliers, and manufacturers. ProjNet-FILER^{SM} has been formally accredited to support the secure exchange of design and construction project information. ProjNet-FILER^{SM} may also transmit related documents to stakeholders, reducing or eliminating the need for independent solutions via tiers of contracts and sub-contracts. Designers may choose to use ProjNet-FILER^{SM} as the primary means of distributing working drawings.

The ProjNet-CCR^{SM} application (Criteria Change Request) allows users to submit requests for changes against existing criteria documents maintained by agencies that subscribe to the ProjNet-CMS^{SM} (Criteria Management System). Once a change request is submitted the management and technical staff responsible for the specific document receive an E-mail with the contents of the change request. The staff evaluates the request and if approved will incorporate it in the Criteria Update section of the system. Criteria Change Requests (CCRs) may also be submitted by members of the Architect/Engineer community directly through ProjNet-CCR^{SM} Web links that exist in the Construction Criteria Base or the Whole Building Design Guide (WBDG) of NIBS, a Web-based tool available at the Web site of NIBS (wbdg.org). The WBDG is a Web-based portal providing one-stop access to current information on building-related guidance, criteria and technology from a “whole buildings” perspective. The site is organized into two major categories, Design Guidance and Project Management. The WBDG also provides Resource Pages, reductive summaries on particular topics. Development of the WBDG is a collaborative effort among federal agencies, private sector companies, non-profit organizations and educational institutions.

The abstract of the disclosure is provided to comply with the rules requiring an abstract that will allow a searcher to quickly ascertain the subject matter of the technical disclosure of any patent issued from this disclosure. 37 CFR § 1.72(b). Any advantages and benefits described may not apply to all embodiments of the invention.

While the invention has been described in terms of some of its embodiments, those skilled in the art will recognize that the invention can be practiced with modifications within the spirit and scope of the appended claims. For example, although the system is described in specific examples for improving the management of government-related construction projects, it may apply to any number of applications including non-government projects and programs that have design aspects that are not related to construction, such as manufacturing processes, product development, research and development, and the like.

In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Thus, it is intended that all matter contained in the foregoing description or shown in the accompanying drawings shall be interpreted as illustrative rather than limiting, and the invention should be defined only in accordance with the following claims and their equivalents.

We claim:

1. A suite of Web-based services that facilitate design review and checking by enabling structured secure communication among contractors, bidders, managers, designers, design managers, contracting officers, contracting office staff, owners, users, customers and other parties associated with design and management of projects to include Requests for Proposals (RFPs) for said projects, said suite for use on a computer and comprising:
at least one design checklist module,
wherein said design checklist module facilitates review of project-related documents and feedback thereon, and
wherein said design checklist module enables collection and sharing of lessons learned, and
wherein said design checklist module integrates a Web-based business process permitting said parties to participate in a design review process using Web browser software and internet access, and
wherein said design checklist module allows said parties to make changes to reflect the evolving nature of work, and
wherein said design checklist module incorporates a feature that integrates E-mail useful for directing correspondence to selected said parties, and
wherein said E-mail may be saved as part of a record of said project;
at least one file management module,
wherein said file management module facilitates the secure exchange of project documents among interested said parties, and
wherein said file management module automatically tracks document creation, deletion, and file views, and
wherein said file management module facilitates audit trails allowing interested said parties to verify those key said parties having access to latest versions of documents related to said projects;
at least one criteria management system (CMS) incorporating at least a criteria change request (CCR) module,
wherein said CCR module facilitates public requests for changes to federal criteria, requirements, regulations and guidelines;
at least one standards and criteria program (SCP) module,
wherein said SCP module permits said parties to coordinate work on shared documents, manage allocation of resources and acquire status of projects in accordance with internal processes and guidelines, and
wherein said CMS allows said parties that are federal agencies that employ the Unified Facilities Guide Specification (UFGS) to manage said CCRs, points of contact for specific documents and control versioning of Government specifications as well as internal regulations and guidelines of said federal agencies;
at least one plan room module,
wherein said plan room module permits said contracting officers to publish contract bid documents to accommodate said RFPs;
at least one bid module,
wherein said bid module permits prospective said bidders on said projects to have questions answered by said contracting office staff;
at least one request for information (RFI) module,
wherein said RFI module permits said contractors to resolve contract issues by employing a formal process administered by said contracting officer;
at least one design quality lessons learned (DQLL^{SM}) module,
wherein said DQLL^{SM} module permits said owners to capture, evaluate, and re-use documentation and resolve recurring issues, incorporate location criteria, and address requirements of said customer;
at least one design manager's module,
wherein said design manager's module aids said designers in controlling internal work processes and allows assignment of discipline lists to assist with comments to be reviewed and approved by said design manager, and
wherein said design manager's module provides specific edit tools and specific reports;
at least one tasker module,
wherein said tasker module is a calendar-based application allowing said managers and said users to manage work on multiple projects identified across any other said Web-based services' modules;
at least one call center module,
wherein said call center module permits capture and resolution of issues related to use of any of said Web-based services' modules;
at least one on-line training module,
wherein said on-line training module permits said users to learn how to use said Web-based services' modules; and
at least one security sub-system,
wherein said security sub-system permits said Web-based services' modules to use a shared security model that enforces federal information processing standards.

2. The suite of Web-based services of claim 1 in which said projects are construction projects.

3. The suite of Web-based services of claim 1 at least part of which is incorporated on computer readable media.

4. A method facilitating design review and checking by enabling structured secure communication among contractors, bidders, managers, designers, design managers, contracting officers, contracting office staff, owners, users, customers and other parties associated with design and management of projects to include Requests for Proposals (RFPs) for said projects, said method for use on a computer and comprising:
providing at least one design checklist module to facilitate review of project-related documents and feedback thereon, to enable collecting and sharing of lessons learned, to integrates a Web-based business process permitting said parties to participate in a design review process using Web browser software and internet access, to allow said parties to make changes to reflect the evolving nature of work, to integrate E-mail useful for directing correspondence to selected said parties, and to save said E-mail as part of a record of said project;
providing at least one file management module to facilitate the secure exchange of project documents among interested said parties, to automatically track document creation, deletion, and file views, and to facilitate audit trails allowing interested said parties to verify those key said parties having access to latest versions of documents related to said projects;
providing at least one criteria management system (CMS) incorporating at least a criteria change request (CCR) module to facilitate public requests for changes to federal criteria, requirements, regulations and guidelines;
providing at least one standards and criteria program (SCP) module to allow said parties to coordinate work on shared documents, manage allocation of resources and acquire status of projects in accordance with internal processes and guidelines, and to allow said parties that are federal agencies that employ the Unified Facilities Guide Specification (UFGS) to manage said CCRs, points of contact for specific documents and to control versioning of Government specifications as well as internal regulations and guidelines of said federal agencies;
providing at least one plan room module to allow said contracting officers to publish contract bid documents to accommodate said RFPs;
providing at least one bid module to allow prospective said bidders on said projects to have questions answered by said contracting office staff;
providing at least one request for information (RFI) module to allow said contractors to resolve contract issues by employing a formal process administered by said contracting officer;
providing at least one design quality lessons learned (DQLL^{SM}) module to allow said owners to capture, evaluate, and re-use documentation and to resolve recurring issues, to incorporate location criteria, and to address requirements of said customer;
providing at least one design manager's module to aid said designers in controlling internal work processes and to allow assignment of discipline lists to assist with comments to be reviewed and approved by said design manager, and to provides specific edit tools and specific reports;
providing at least one tasker module as a calendar-based application allowing said managers and said users to manage work on multiple projects identified across any other said Web-based services' modules;
providing at least one call center module to allow capture and resolution of issues related to use of any of said Web-based services' modules;
providing at least one on-line training module to allow said users to learn how to use said Web-based services' modules; and
providing at least one security sub-system permitting said Web-based services' modules to use a shared security model that enforces federal information processing standards.

5. The method of claim 4 said projects comprising construction projects.

6. The method of claim 4 incorporating said modules, said systems and said sub-systems on computer readable media.

7. The method of claim 4 enabling structured secure communication among said parties associated with design and management of said projects.

8. The method of claim 4 further comprising:
submitting said Criteria Change Request (CCR) to be stored in a database of said CMS;
sending an E-mail assigning said CCR to a technical representative;
acting on said E-mail notice by said technical representative;
developing a cost and time estimate;
storing said CCR and said estimate in said standards and criteria program (SCP) module;
checking availability of funding;
storing said CCR and said estimate in the ProjNet^{SM} database if funding is not available;
updating said criteria if funding is available, and
notifying a subject matter expert (SME) listed in said DQLL^{SM}.

8. The method of claim 7 said submitting made via a SME associated with said DQLL^{SM} module.

9. The method of claim 4 further comprising:
identifying at least one issue by a submitter;
initiating a general query as to whether said issue is addressed in an existing lesson,
wherein if uncertainty exists as to whether the issue is new, initiating a search of said DQLL^{SM} database;
inserting said existing lesson into comments for said project if a lesson does exist and drafting a new lesson if a lesson does not exist and inserting said new lesson into said comments for said project;
sending an E-mail notice of said new lesson to a subject matter expert (SME);
evaluating said new lesson by said SME;
notifying said submitter by E-mail if said new lesson is found to be of no merit or duplicative;
approving said new lesson if found to have value by said SME and notifying said submitter by E-mail;
determining if a criteria action is required,
wherein if said criteria action is required, creating a criteria change request (CCR), and
wherein if no criteria action is required, then storing said new lesson is stored in said DQLL^{SM} database.

10. The method of claim 9 further comprising:
questioning the validity of said new lesson at any time,
wherein said questioning is based on updated criteria from said Criteria Management System (CMS),
upon finding said new lesson, allowing said new lesson to remain stored in said DQLL^{SM} database, and
updating said DQLL^{SM} database upon finding said new lesson to have been superseded or duplicative.

11. The method of claim 10 further comprising initiating said search by a general query unrelated to an issue.

12. The method of claim 4 further comprising:
initiating a comment process;
deciding whether it is appropriate to copy said comments;
if it is appropriate to copy said comments, searching a check function;
if at least one item is found, creating a comment;
if it is decided not to copy said comments, deciding whether to copy said lessons;
if said lessons are to be copied, searching said DQLL^{SM} database;
if at least one item is found, creating a comment;
if neither one nor both of said comments or lessons are copied, creating a comment noting this;
determining if a lesson is to be documented;
if said lesson is to be documented, submitting a draft through said Lessons Learned process and
providing said draft to at least one said designer to evaluate; and
if said lesson is found not to be required, said designer evaluating said initial comment.

13. The method of claim 12 said initiating accomplished by at least one said designer.

14. The method of claim 12 said check function being for DrChecks^{SM} in the ProjNet^{SM} program.

15. The method of claim 12 further comprising said submitter initiating a backchecking process on said evaluation after completion of said evaluation of said design manager,
wherein if said submitter agrees with said designer, storing said comment in said checking function together with said evaluation and said backcheck, and
wherein if said submitter disagrees with said designer, sending said evaluation back to said designer for an additional evaluation; and
re-cycling said backchecking process until said submitter agrees with said additional evaluation.

16. The method of claim 4 further comprising:
assigning secondary disciplines to sort said comments for action,
wherein said assigning is accomplished by at least one design manager;
controlling assignment of evaluations;
preventing select said project parties from seeing said evaluations until said evaluations are completed;
asking at said comment review if disciplines are correct,
wherein said asking is done by at least one design manager;
if disciplines are not correct, assigning correct disciplines;
if disciplines are correct, determining if said assignments are correct;
if said assignments are correct, completing said evaluation;
if said assignments are not correct, revising said assignments; and
posting said comment evaluations once said evaluation is complete and backchecked for backchecking by said submitter.

17. The method of claim 4 further comprising employing Project ExtraNet (ProjNet^{SM}), a suite of Web-based services for the secure structured information exchange of design and construction information among authorized business partners in the context of specific business processes, in particular those partners, including government agencies, associated with government contracts.

18. The method of claim 17 further comprising providing a suite of services available through ProjNet^{SM} comprising:
DrChecks^{SM};
QuickPick,
wherein said QuickPick allows retrieving of relevant past review comments, lessons learned, and specific checklists;
ProjNet-FILER^{SM},
wherein said ProjNET-Filer^{SM} provides for secure exchanging of electronic documents available through said ProjNet^{SM};
ProjNet^{SM} Criteria Management System (ProjNet-CMS^{SM}),
wherein said ProjNet-CMS^{SM} allows federal agencies using UFGS to manage and control content of requested changes to government-wide specifications as well as internal regulations and guidelines;
ProjNet^{XM} Criteria Change Request (ProjNet-CCR^{SM}) tool,
wherein said ProjNet-CCR^{SM} allows making criteria changes requests (CCRs) to federal criteria, requirements, regulations and guidelines, and
wherein said ProjNet-CMS^{SM} maintains a record of said CCRs;
ProjNet^{SM} Standards and Criteria Program (ProjNet-SCP^{SM}),
wherein said ProjNet-SCP^{SM} allow agencies to coordinate, manage and fund work on shared documents, regulations and guidelines, and
wherein said ProjNet-SCP^{SM} allows managing funding necessary to implement said CCRs stored in said ProjNet-SCP^{SM}, and
wherein said ProjNet-SCP^{SM}, said ProjNet-CCR^{SM} and said ProjNet-CMS^{SM} are interdependent and share a common database;
ProjNet-PlanRoom^{SM},
wherein ProjNet-PlanRoom^{SM} allows said contracting officers to publish on the internet said contract bid documents and RFPs;
ProjNet-BID^{SM},
wherein said ProjNet-BID^{SM} allows said prospective bidders to have questions on a bid package answered by said contracting office staff;
ProjNet-Design Quality Lessons Learned (ProjNet-DQLL^{SM}),
wherein said ProjNet-DQLL^{SM} allows said owners to capture, evaluate, store and re-use lessons learned related to recurring issues, location specific issues, and said requirements of said customer;
ProjNet-Design Manager's Module (ProjNet-DMM^{SM}),
wherein said ProjNet-DMM^{SM} allows said designers to hide intermediate work products from other review participants, edit review evaluations, assign others to accomplish the evaluations and assign firm specific secondary disciplines for internal sorting and processing, and
wherein said ProjNet-DMM^{SM} provides pre-specified edit tools and pre-specified reports;
e-TASKER^{SM},
wherein e-TASKER^{SM}, allows said managers and said users to manage work on multiple projects identified across any application of said ProjNet^{SM};
Call Center,
wherein said Call Canter allows capture and resolution of issues related to use of any application of said ProjNet^{SM};
On-line Training,
wherein said On-line Training facilitates learning by new said users and facilitates updating of existing said users;
ProjNet-Request For Information (ProjNet-RFI^{SM}) module,
wherein said ProjNet-RFI^{SM} facilitates responding by said contracting staff to requests by said contractors; and
at least one Security Sub-System,
wherein said Security Sub-System facilitates said ProjNet^{SM} applications in using a shared security model that enforces federal information processing standards.

19. The method of claim 18 further comprising creating information distribution portals for the distribution of standard design documents, guidelines, Architect/Engineer guidelines, and standards,
wherein content at said portals is managed by said subject matter experts and overseen by administrators, and
wherein managers of said portals update contacts to keep all said parties abreast of latest standards.

20. The method of claim 18 further comprising distributing working drawings via ProjNet-Filer^{SM} as the primary means of distributing said working drawings.
